(19) United States
(12) Patent Application Publication
(10) Pub. No.: US 2008/0244691 A1
(43) Pub. Date: Oct. 2, 2008

(54) Dynamic threat vector update

(76) Inventors: Israel Hilerio, Kenmore, WA (US); Eric B. Watson, Redmond, WA (US); Lingan Satkunanathan, Kirkland, WA (US); Krishna Sunkammurali, Sammamish, WA (US); Bjorn B. Levidow, Bellevue, WA (US)

Correspondence Address: MICROSOFT CORPORATION, ONE MICROSOFT WAY, REDMOND, WA, 98052-6399, US

(21) Appl. No.: 11/731,222

(22) Filed: Mar. 30, 2007

(51) Int. Cl. G06F 17/00

(52) U.S. Cl. 726/1

(57) ABSTRACT

A security manager aggregates various security components into a unified user interface. For each security component, the security manager may obtain an updated policy description that defines specific groups of settings for the component in terms of several threat conditions. Using the groups of settings, the security manager may classify a current state of a security component into a category. Some embodiments may use a standardized schema for an interface between a security component and the security manager. The schema may be implemented with an adapter that translates the specific settings of a security component into data for the security manager. In some embodiments, the adapter may also receive updated policy descriptions and perform a classification of the current settings.

### BACKGROUND

Effective computer security may comprise many different mechanisms. Firewalls, spam filters, email scanners, and a host of anti-virus or anti-malware devices, software, and other mechanisms are employed to keep a computer or network secure. Each of the mechanisms or components may be provided by different vendors that specialize in a specific niche of computer security.

In many cases, several devices on a network may be used to perform different functions in an overall security system for a network. For example, one device may serve as a firewall, another for email processing, and each device on the network may have a local anti-malware system. Some security components may be updated periodically, such as an email processing system that may scan for the latest viruses, Trojan horses, or worms. Other devices, such as a firewall, may not be updated often.

### SUMMARY

A security manager aggregates various security components into a unified user interface. For each security component, the security manager may obtain an updated policy description that defines specific groups of settings for the component in terms of several threat conditions. Using the groups of settings, the security manager may classify a current state of a security component into a category. Some embodiments may use a standardized schema for an interface between a security component and the security manager. The schema may be implemented with an adapter that translates the specific settings of a security component into data for the security manager. In some embodiments, the adapter may also receive updated policy descriptions and perform a classification of the current settings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with several security components.

FIG. 2 is a diagram of an embodiment showing an architecture of a security manager.

FIG. 3 is a flowchart of an embodiment showing a method for updating a security manager database.

FIG. 4 is a flowchart of an embodiment showing a method for adding security components to a security manager.

FIG. 5 is a flowchart of an embodiment showing a method for performing two management functions.

### DETAILED DESCRIPTION

A security manager may consolidate the status of many security components in a network environment. The status of each component may be summarized in a classification of security policy strength that may be tailored for each security component. The classification may be determined from a set of policy rules that are obtained from a remote server.

The security manager may have a unified user interface that displays the status of various security components. The user interface may consolidate many different security components, such as firewalls, email filters, web content filters, anti-malware scanners, and any other security components into a single user interface. The components may connect to the security manager through an adapter that converts component-specific data into a schema recognized by the security manager.

Each security component may have a policy strength determined by comparing the current settings of the security component with a set of best practice settings. The set of best practice settings may have a classification definition, such as a ranking of high, medium, or low security. In some instances, a set of custom policy definitions may be created.

A remote server may be queried to determine a current set of best practice settings for each component. The remote server may be updated frequently with best practice definitions for specific components to respond to immediate security threats.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, microcode, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

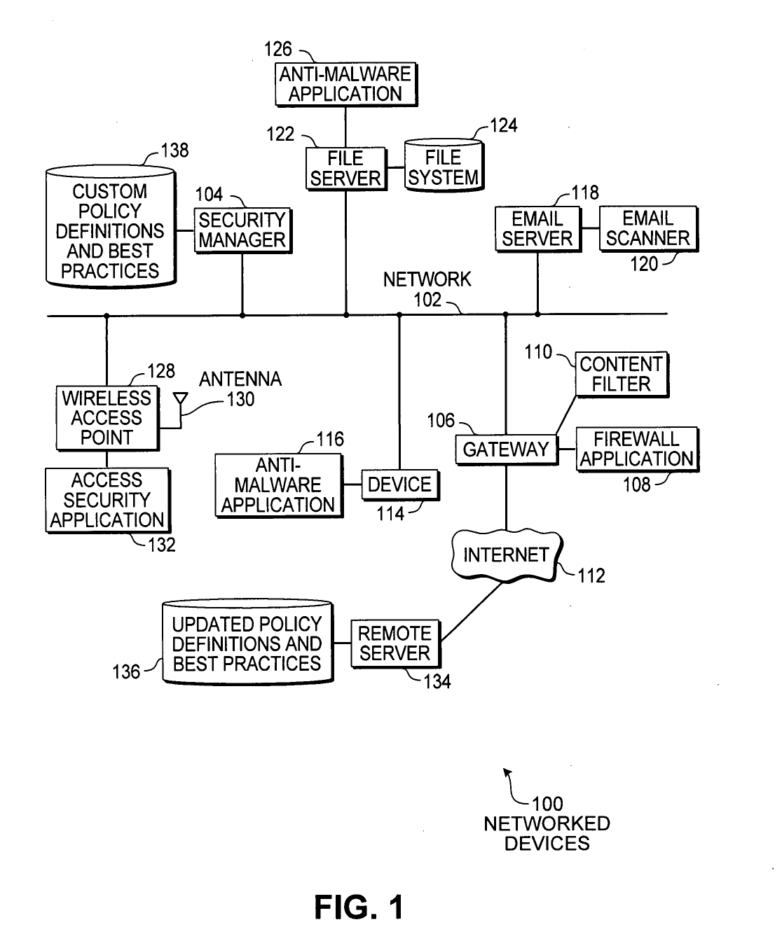

FIG. 1 is a diagram of an embodiment 100 showing a system of networked devices with security components. Various devices may have different security components for protecting the specific device as well as protecting the network and other devices on the network. A security manager 104 may provide a central point of management and control of the various components. Some networks may have many hundreds or thousands of devices that may be spread over a wide geographical region.

The security manager 104 may consolidate the status of various security components into a unified user interface. The security manager 104 may also be able to adjust settings and capabilities of different security components by communicating over the network 102.

The security manager 104 may operate on a dedicated device or may operate on a device that performs many different functions. In a typical computer network, the security manager 104 may be a service or application that operates on a server computer. In some embodiments, the security manager 104 may be located remotely from the network 102 and may be operated through the Internet 112.

The network 102 and the various devices may be any type of communications network with any type of attached device. In some cases, attached devices may be personal or server computers, handheld devices such as personal digital assistants or cellular phones, network appliances, network attached storage devices, network routing and switching devices, dedicated devices, or any other device that may perform a security role or be affected by security systems.

In the current embodiment, a gateway device 106 may have a firewall application 108 and a content filter 110. The gateway device 106 may connect the network 102 to the Internet 112. In many instances, the gateway device 106 may be a dedicated device such as a DSL or cable modem. In other instances, a dedicated gateway device may be a general purpose computing device. In still other instances, the gateway device 106 may be a server device that provides firewall functions as well as other functions such as email or file services.

The firewall application 108 may be a computer application that is configurable to allow or disallow certain connections between the network 102 and the Internet 112. For example, the firewall application 108 may permit certain ports to be open or may provide proxy services for connections. Various technologies may be used to perform firewall functions.

The content filter application 110 may block certain types of transmissions based the content of those transmissions. For example, a version of a content filter 110 may prevent a web browser from receiving pornographic material. In some instances, a content filter 110 may evaluate the contents of each packet of information, while in other instances, a content filter may maintain a list of permitted or excluded addresses for communications. In some cases, a firewall 108 or content filter 110 may enable or disable certain applications from accessing the Internet 112. For example, some embodiments may prohibit chat programs from Internet access.

The device 114 may have an anti-malware application 116. Anti-malware applications may protect a device against attacks by viruses, Trojan horses, worms, or other malicious software. The anti-malware application 116 may perform a security service directed to the device 114, in contrast to the firewall application 108 and content filter 110 that provide a security service for the various devices on the network.

An email server 118 may have an email scanner application 120 that performs scans of incoming and outgoing email. Such scans may detect malicious embedded code, scan for specific content such as classified or confidential material, ensure that email conforms to a company standard, or any other function.

Some security components may perform functions that vary with the user. For example, a customer service representative may be permitted to engage in online chat or receive email from clients. Other personnel may be prohibited from online chat and their email may be filtered.

A file server 122 may provide file system services 124 that are shared across several devices on the network 102. The file server 122 may have a server-capable anti-malware application 126 that may be designed to provide protection to the file system 124. For example, the anti-malware application 126 may scan new files that are added or modified within the file system 124 or may perform scans of files within the file system 124 on a periodic basis.

A wireless access point 128 may have an antenna 130 and provide connectivity to various wireless devices. The access point 128 may be susceptible to intruders and may have an access security application 132 that may monitor wireless traffic as well as configure the access point 128 with various security settings.

The security manager 104 may collect information from the various security components on the network and provide a consolidated view of the components. In many cases, different security components may be developed, sold, and maintained by specialized manufacturers, and thus may not be directly amenable to operating through a unified interface. In order to provide a unified interface, each security component may have an adapter which converts information obtained from the security component into a standard schema that the security manager 104 may utilize.

Part of the unified schema may be a rating of the policy strength for the particular security component. Policy strength may be a summary of the various settings and capabilities of a security component. In many cases, such a summary may be a simple classification such as high, medium, and low security. Policy strength may also be represented by levels of security defined by colors such as red, orange, yellow, and green. Another embodiment may use a policy strength defined as a numerical value that may be an integer or real number. Such a numerical value or color designation may be calculated using complex formulas in some cases.

In many cases, a policy strength may be defined using a set of rules defined for each component. For example, an anti-malware application may have the following rules to define a policy strength in Table 1:

TABLE 1
Policy Strength Example

| | Auto | | | |
|---|---|---|---|---|
| Policy | Download | Auto Scan | Polling Interval for | Policy |
| Rule | Frequency | Frequency | Server Updates | Strength |
| 1 | Freq <= 2 days | Freq <= 2 Days | Freq <= 2 Days | High |
| 2 | 5 Days >= | 5 Days >= | 5 Days >= Freq > | Medium |
| | Freq > 2 Days | Freq > 2 Days | 2 Days | |
| 3 | Freq > 5 Days | Freq > 5 Days | Freq > 5 Days | Low |

In the example of Table 1, three different rules are shown that may be applied to an anti-malware application. The rules have parameters that are specific to an anti-malware application. The parameters may be common to many anti-malware applications or may be specific to a particular version of a specific anti-malware application.

In the first rule, if the frequency of auto download, auto scan, and polling interval for server updates are less than two days, the policy strength is defined as high. Similarly, the second rule states that if the frequency of the operations is between 2 and 5 days, the policy strength is medium. The third rule states that when the frequency is greater than 5 days, the policy strength is low. Different rules may use different definitions, including logical AND and logical OR operators to define the rules.

The parameters of auto download frequency, auto scan frequency, and polling interval may be specific to anti-malware security components. For other security components, for example the access security application 132 on the wireless access point 128 or the firewall application 108, the parameters may be much different.

The security manager 104 may use an adapter with each security component that converts component-specific information into a schema that is common to many security components. In some instances, an adapter may perform the specific analysis or determination of a policy strength. In other instances, such analysis may be performed within the core of the security manager 104.

A policy strength may be determined by many different mechanisms. Some embodiments may use rule definitions such as in Table 1 to define specific classifications of policy strength. Other embodiments may define a policy strength using a calculated formula that yields an integer or real number result. Still other embodiments may use a Boolean logic definition, a workflow definition, or any other logic definition scheme to define a policy strength.

A set of best practice settings may be defined for each security component, and may contain a policy strength definition for the component. Best practices may be defined and updated over time as threats change for a specific security component. For example, a set of best practices may define a high policy strength for an email scanning component to update a virus database on a weekly basis initially. Over time, especially when a virus attack is anticipated, a set of best practices may change the definition of a high policy strength to update a virus database twice daily.

In some instances, a set of best practices may encompass several security components. For example, a network gateway may comprise two different firewalls in series. Each firewall may have different functions, but the combined effect of both firewalls may be defined in a set of best practices that incorporates the settings of both firewall devices.

The set of best practices may be used to analyze current security component settings and provide a user or administrator with an evaluation of the current security state for individual security components, groups of security components, or an entire network with various security components.

A set of best practices may be a policy strength definition for a security component, where the policy strength definition may define a classified security strength, such as high, medium, and low. In other cases, a set of best practices may include a formula that determines a calculated numerical policy strength and a set of rules that classifies the policy strength into various discrete levels. The set of best practices may include any type of logic, from one or more simple rules to complex logic using artificial intelligence techniques.

In some embodiments, a set of best practices may be defined separately from a policy definition. For example, a policy definition may determine a summary value of a current state of a security component. A set of best practices may be used to interpret the summary value into a classification that has an intuitive meaning to a human administrator. In some cases, a policy definition may be a subset of the set of best practices, while in other cases, a policy definition may equal to the set of best practices.

The security manager 104 may periodically query a remote server 134 to obtain updated policy definitions and set of best practices 136. The remote server 134 may be a centralized server that contains best practices and policy definitions for many different security components. In some embodiments, each security component may have a separate remote server 134 that is maintained and updated by a vendor or manufacturer of the security component.

The remote server 134 may provide adapters, metadata, or other services for one or more security components that enable the security manager 104 to connect and operate the security component. In some cases, such services may be provided by a manufacturer of the security component, by the manufacturer or developer of the security manager 104, or by a third party.

A custom policy definition and best practices database 138 may be used by the security manager 104 to store and apply policy definitions and best practices that are modified or adapted for a specific installation. In some cases, an administrator may wish to create a set of policy definitions for a specific network implementation, which may be applied instead of or in conjunction with updated policy and best practices 136 obtained from a remote server 134.

In some embodiments, a set of best practices may be updated and maintained separately from policy definitions. For example, a set of best practices may define a set of logic used to interpret various policies. The best practice definition may stay constant while a policy definition may be updated or vise versa. In some embodiments, such as the rules defined in Table 1, the set of best practices and the policy definitions may be one and the same.

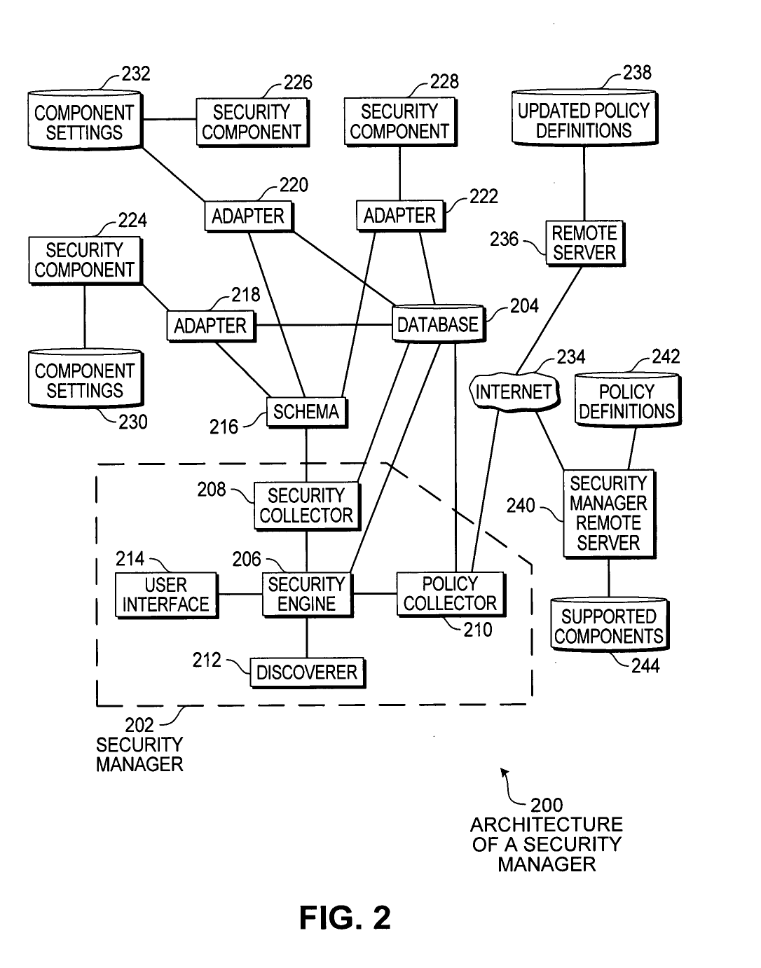

FIG. 2 is a diagram illustrating an embodiment 200 showing an architecture for a security manager. Embodiment 200 is an example of how a security manager 202 may be configured. In other embodiments, various portions of the security manager 202 may be combined or divided into different components with fewer or more features and capabilities.

The security manager 202 may comprise a security engine 206, a security collector 208, a policy collector 210, a discoverer 212, and a user interface 214. The security engine 206 may perform overall coordination, sequencing, and communication between the various other components in the security manager 202. The security manager 202 may use a database 204 for storing data, including data that are shared across different components of the security manager 202.

The security collector 208 may collect data from various security components through a standardized schema 216. The schema 216 may define a common communications mechanism between disparate and unrelated security components so that a single user interface may be used to monitor and control many components. The various adapters 218, 220, and 222 are used to connect to security components 224, 226, and 228, respectively.

Adapter 218 may connect to security component 224 that has an attached set of component settings 230. The adapter 218 may interface directly with the security component 224 to perform various functions, including obtaining various data and sending updated configuration settings. The adapter 218 may connect to the security component 224 through an application programming interface (API) on the security component 224 that exposes some commands or functions.

The data that is obtained from a security component may vary greatly from one embodiment to another, and from one security component to another. Similarly, the commands or functions that a security manager 202 may be able to perform with a security component may vary widely between embodiments. In many cases, the data obtained from a security component may be data that are used in the calculation or determination of a policy strength, a current status, information about any related servers available on the Internet. The data may also include data concerning recent operations such as the date and time of recent updates, number of files processed, any errors detected, logs of events, or any other status data.

A security component may also include information about servers on the Internet. Such servers may be able to provide updated adapters, updated policy strength definitions, or other data that may be used by the security manager 202 to configure, control, or operate with the security component.

The adapter 220 may provide an interface with security component 226 by dealing directly with a component setting file or database 232. The adapter 220 may read and write to the component settings 232 to obtain information and to change configuration settings for the security component 226. Such an interface may involve reading and writing to a file as opposed to sending a communication and receiving a response as with the adapter 218.

The adapter 222 may provide an interface with security component 228 in any manner.

The various security components 224, 226, and 228 may be located on the same device as the security manager 202. In some cases, the security components 224, 226, and 228 may be located on devices connected through a local area network (LAN) or a wide area network (WAN), including the Internet. In some instances, a security manager 202 may reside in one location and manage security components on a local area network that is hundreds of miles away. The security manager 202 may connect to and manage a set of security components through the Internet.

In some embodiments, the adapters 218, 220, and 222 may use data from the database 204. For example, in some embodiments the adapters 218, 220, and 222 may use a policy definition or set of best practices to evaluate a current policy state for a security component. In other embodiments, such evaluations may be performed by the security collector 208.

In some embodiments, the adapters 218, 220, and 222 may write data directly to the database 204. In other embodiments, the security collector 208 may perform some processing or analysis of incoming data prior to storing the data in database 204.

The policy collector 210 may collect updated policy definitions from various sources on the Internet 234 and store the updated policy definitions in the database 204. In one case, the policy collector 210 may connect to a remote server 236 that has updated policy definitions 238. The remote server 236 may be a server that is specific to a particular security component. In such an embodiment, the policy collector 210 may query several different remote servers 236 to update the database 204 with policy definitions for each security component.

The policy collector 210 may be able to connect to a security manager remote server 240 that has a set of policy definitions 242. The security manager remote server 240 may have information for many different security components, including policy definitions 242. The security manager remote server 240 may also contain a database with supported security components 244.

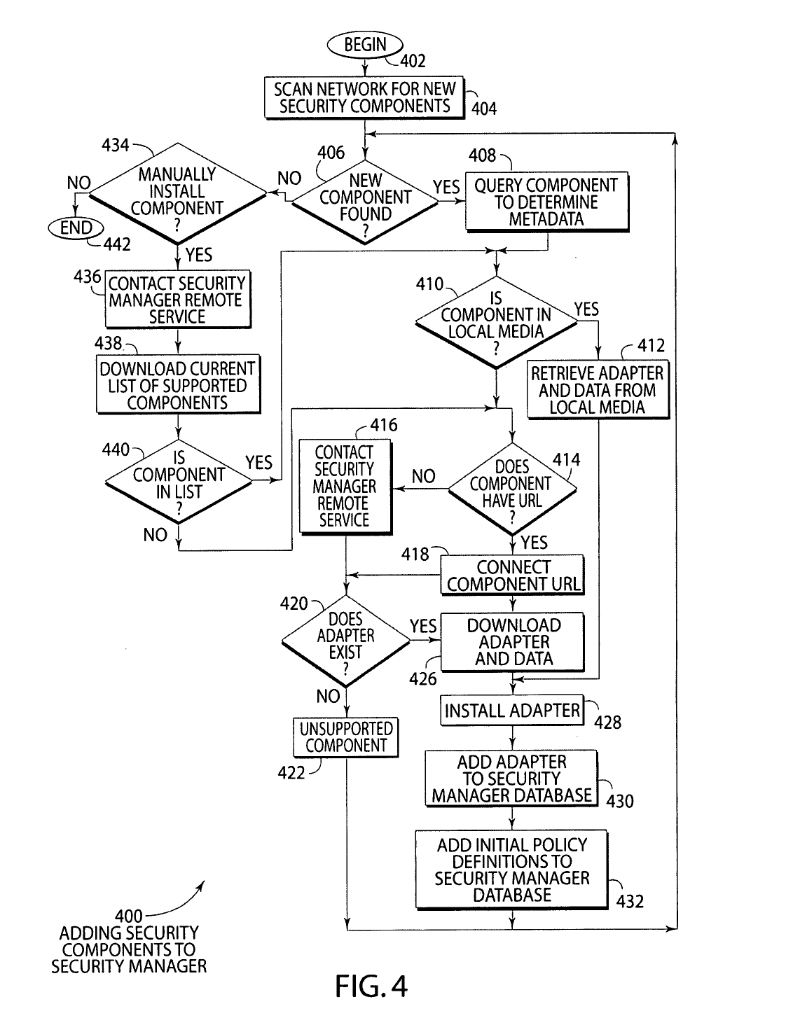

The database with supported security components 224 may be used by the discoverer 212 to discover new security components and install the components into the security manager 202. The installation process may include obtaining an adapter for the new security component from the security manager remote server 240, the remote server 236, the security component itself, from a local media that contains various adapters, or any other source. The installation process may also include adding the new security component to the database 204. An example of the operation of a discoverer 212 may be found in embodiment 400 in FIG. 4 later in this specification.

The user interface 214 may display data from and metadata about the various security components. In some instances, the user interface 214 may be used to consolidate all of the various security components into a single view, categorize the components in different manners, display details about each component, or perform any other data display and manipulation functions. In many embodiments, the user interface 214 may obtain data from the database 204 for display.

The user interface 214 may also serve as a mechanism by which a user or administrator may change various settings for a security component. In some instances, the detailed settings for a specific security component may be displayed and a user or administrator may be able to change some or all of the values of the settings. When new settings have been defined, the security manager 202 may be able to update the settings of the specific security component. In some instances, the security manager 202 may be able to overwrite or change settings in a configuration file used by a security component, such as with adapter 220. In other instances, the security manager 202 may be able to send a communication to the security component to change a setting as with adapter 218. Other instances may use other communications mechanisms or techniques for changing the settings for a security component.

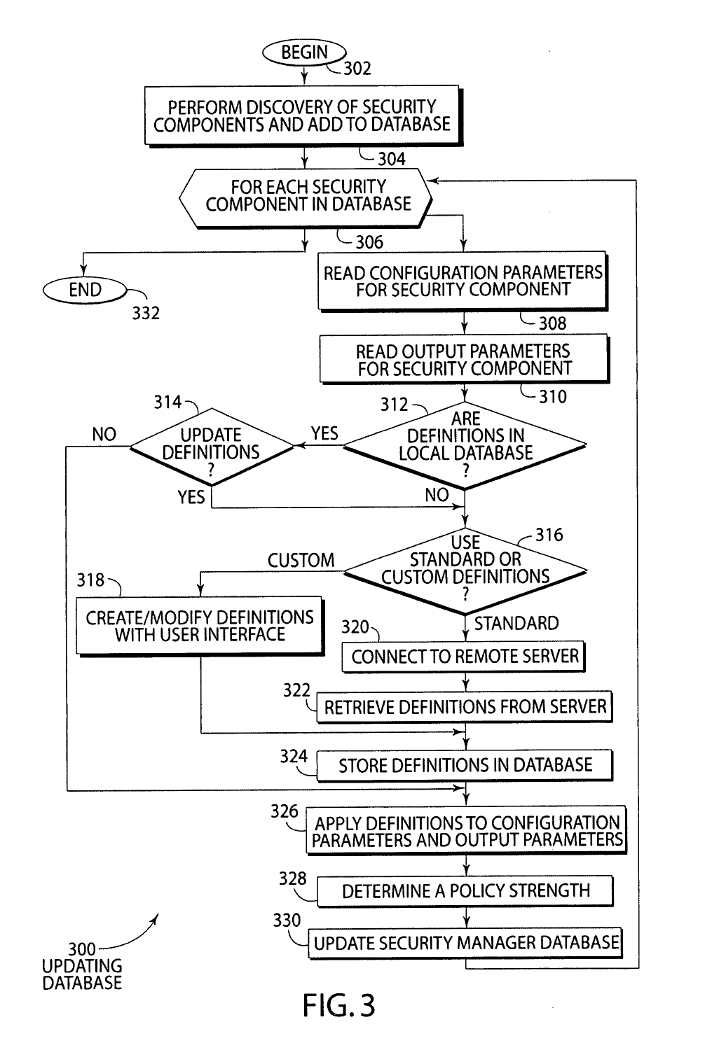

FIG. 3 is a flowchart illustration of an embodiment 300 showing a method for updating a security manager database, such as database 204. After adding any new components, the embodiment 300 steps through each security component and updates the rules or policy definitions for the component. In some instances, the rules may be a custom rule created or modified by a user or administrator. The rules are used to determine a policy strength parameter and store the parameter in the database.

In block 304, a discovery action is performed and new security components are added to the database. A more detailed embodiment is discussed later in this specification. In some embodiments a security manager application may scan devices to determine if a new security device has been added. In other embodiments, an installation process for a security device may include detecting and notifying a security manager. In some such embodiments, adapters may be downloaded from a remote server or installed from media that is shipped with a security manager application.

The discovery action may also include determining if a new version of an adapter or associated data is available from a remote server, such as a remote server accessed over the Internet. In some cases, a remote server may notify the security manager application that an updated version of an adapter or data is available for download.

For each security component in the database in block 306, the database may be updated using the following method.

The configuration parameters for a security component are read in block 308 and output parameters are read in block 310. In some embodiments, a security component may have configuration parameters that are used by the security component to configure itself to perform specific functions. For example, a firewall security component may have several configuration parameters that define which ports are open and which are closed. A security component may also have output parameters that may include the status of the component and other data including performance data. In the example of a firewall security component, an output parameter may be the number of packets processed in a certain period of time or the peak throughput of the firewall. The firewall component may also provide output parameters that include a current operational status.

If policy definitions are in the local database in block 312, a determination is made in block 314 if the definitions are to be updated. If the definitions are to be updated in block 314, and custom settings are to be used in block 316, the definitions are created or modified with the user interface in block 318. If the standard definitions are used in block 316, a connection is made to a remote server 320 and definitions are retrieved in block 322. Updated definitions from blocks 322 or 318 are stored in the database in block 324.

The process from block 312 to block 324 illustrates one set of logic that may be used to determine how a policy or best practices definition may be updated. In some embodiments, the definitions may be updated at each execution of a security manager. In other embodiments, a definition may be updated when a notification has been received by a remote server that a new definition is available. In still other embodiments, definitions may be updated on some periodic basis such as weekly, monthly, or some other interval.

Definitions may be in a local database in block 312 from a previous operation of the method 300 or from an installation sequence that added the definitions. In some cases, definitions may be removed if the definitions expire and thereby force a new set of definitions to be added to the database. In other cases, definitions may not be present because the method 300 has not yet been executed for a newly installed security component.

A user may have custom definitions for policy definitions or best practices that may be developed and defined for the user's specific implementation. In such a case, a user interface may be used in block 318 to define the rules. The definitions may be defined and captured using any type of user interface, including a selection of pull-down menus with different options, spaces for inputting values of numbers or text, or a scripting interface where a user may write or edit a script that defines the policy definition.

In block 326, the definitions may be applied to the current configuration parameters and output parameters obtained in blocks 308 and 310. The manner in which the definitions are applied is dependent on the type of definition and the data. Various embodiments may perform any type of evaluation to determine a policy strength in block 328, which is added to the database in block 330. After each security component is evaluated in block 306, the process ends in block 332.

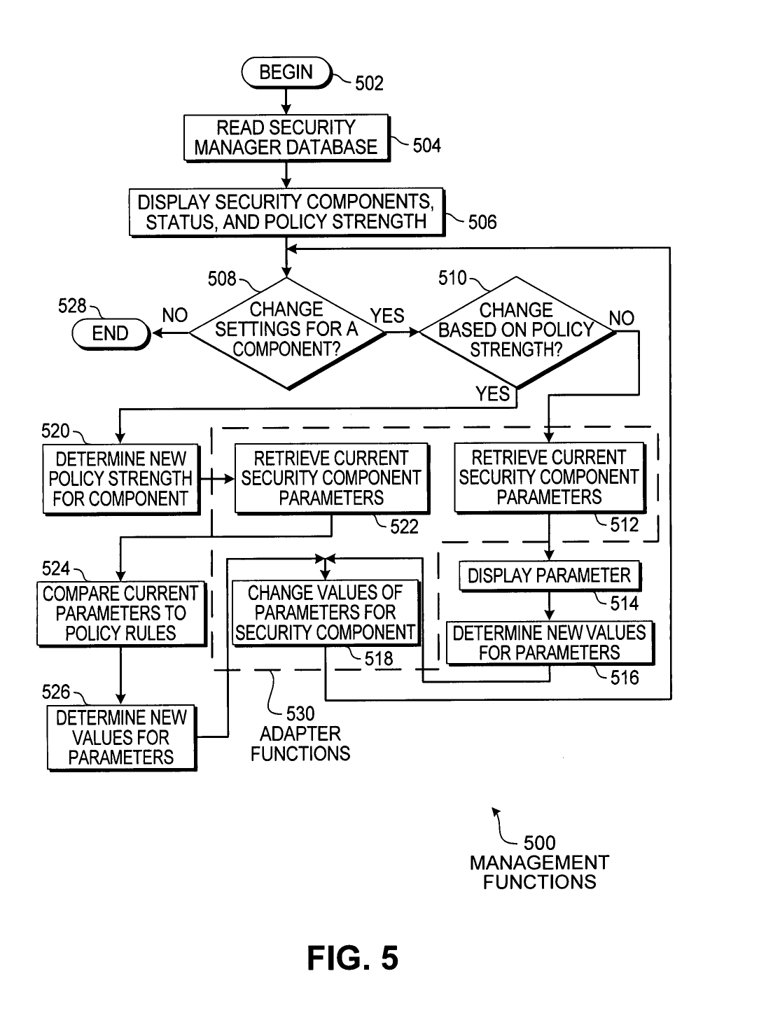

The embodiment 300 illustrates a mechanism by which the database associated with a security manager may be updated. Once the database is updated, other functions may be performed on the data, as will be discussed later in FIG. 5.

FIG. 4 is a flowchart illustration of an embodiment 400 of a method to add security components to a security manager. A new security component may be added manually or automatically discovered. During the installation process, remote servers may be contacted to find adapters and other information that may be used in the installation process. Embodiment 400 may represent an embodiment of block 304 of embodiment 300.

The process begins in block 402. A scan of the network for new security components may be performed in block 404. The scan be use any mechanism for automatically determining that a security device is present. In some instances, security devices may self-register with a security manager for installation. In other instances, a specific folder in a file system, registry setting, or other data may be modified on a device that may indicate that a new security component is present on the device. In still other instances, a broadcast network message may be sent to request any security component to respond. In some embodiments, one or more of the above mechanisms or any other mechanisms may be used to detect new security components.

If a new component is found in block 406, a query may be made to the component to determine some metadata about the component in block 408. In some instances, a security component may be able to return various metadata about the component to a security manager. Such metadata may include a description of the component, addresses including Uniform Resource Locators (URL) for remote servers that may be able to provide additional metadata or policy definition updates, or other useful metadata. In some cases, a URL may be used for a local location, such as on a distribution disk, a locally installed component, or a component accessible through a local area network. In other cases, a URL may point to a location accessed through the Internet or other wide area network.

In some embodiments, a security component may be detected but may not be able to respond to a query. Some embodiments may have different mechanisms for determining the identity of the new security component, including examining files, registry settings, or other data that may identify the new component. In some embodiments, the identity of the new component may be determined by active interaction and communication between a security manager and a security component. In other embodiments, a security component may be identified by collecting data without an interaction.

If the component is listed in a local media repository in block 410, an adapter and other data may be retrieved from the local media in block 412. An example of local media may be a database that is installed with a security manager that contains adapters and other information about various security components. The database may be installed on a hard disk or other media that is readily accessible or on a Compact Disk (CD), Digital Versatile Disk (DVD), or other removable media.

The data included with an adapter in block 412 may include default or initial policy definitions as well as various parameters that may be used by the security manager for naming the component, communicating with the component, or performing any other task.

If the component does not have a URL in block 414, a remote service related to the security manager may be contacted in block 416. If no adapter exists on the security manager remote server in block 420, the component may be unsupported in block 422 and the process returns to block 406.

If the component has a URL in block 414, the component URL is contacted in block 418. If no adapter exists in block 420, the component may be unsupported in block 422. If the adapter exists in block 420, either from the security manager remote server of block 416 or the component URL in block 418, the adapter and data are downloaded in block 426.

The downloaded adapter from block 426 or the adapter retrieved from the local media in block 412 is installed in block 428. The adapter is added to the security manager database in block 430 and initial policy definitions are added to the database in block 432.

If no new component is found in block 406, a manually installed component may be installed in block 434. If a manual installation is chosen in block 434, the security manager remote service may be contacted in block 436 and a current list of supported security components may be downloaded in block 438. If the component is within the list in block 440, the process continues in block 410 with downloading an adapter and data. If the component is not in the list in block 440, the process continues with block 414 with attempting to locate an adapter and data. If no component is to be added manually in block 434, the process ends in block 442.

The embodiment 400 is one embodiment of a mechanism by which new components may be added to a security manager. Other embodiments may have different mechanisms for adding or installing new security components.

FIG. 5 is a flowchart illustration of an embodiment 500 showing various management functions for a security manager. Two functions are illustrated: displaying data from and metadata about security components and updating security components.

The security manager database is read in block 504. Using the data from the database, various displays of security component data and metadata may be performed in block 506. For example, a list of installed components may be displayed along with the current status of the components and the policy strength for the component. In some instances, a policy strength may be shown for the aggregation of two or more or all of the installed security components.

In block 506, a user may be able to sort the display, group the security components, drill down into the data to display more detailed data, or any other manner of manipulating the available data for viewing.

If a change is to be made to a component in block 508, a user may be able to make a change based on a policy strength value in block 510. If not making a change using policy strength definition in block 510, the user may be able to change individual parameters by retrieving current security component parameters in block 512, displaying some or all of the parameters in block 514, and determining new values for the parameters in block 516.

Any type of user interface may be used to display and change parameters in blocks 514 and 516. In some instances, a user may display and change parameters by editing a configuration file using a text editor, while in other instances, a graphical user interface may present the data and various graphical user interface tools may be used to select or change different values. Once the values are changed, the values are updated for the security component to use in block 518.

The parameters displayed and changed in blocks 514 and 516 may be specific parameters used by a security component. Because these parameters are specific to a security component, the parameters may be very detailed and may enable an administrator to have a great deal of control over the specific changes made. However, such changes may use a high degree of knowledge about the security component and the specific functions that it performs.

A user may be able to change the performance or actions of a security component by selecting an updated policy strength value in block 510. For example, a user may be able to select a policy strength of “high” for a security component and may not wish to change very detailed parameters individually.

Through a user interface, a user may determine a new policy strength for a security component in block 520. Current parameters for the security component are retrieved in block 522 and are compared to policy rules or definitions in block 524. Based on the comparison in block 524, new values for the parameters may be determined in block 526. Once the new values are determined, changes may be made to the current parameters for the security component in block 518.

If no changes are made to a security component in block 508, the process ends in block 528.

The functions of blocks 512, 518, and 522 may be performed by an adapter for the security component. In blocks 512 and 522, current settings for a security component configuration are retrieved. In block 518, the settings for the security component are changed. Communication with the security components may be performed in many different manners, and each component may have a different adapter able to perform the communication in a manner specific for the component. In some embodiments, other functions may also be performed by an adapter, including blocks 524 and 526 where policy rules or definitions are compared with current parameters to determine which parameters are to be changed. The configuration and functionality of adapters may be different for various embodiments.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A security manager comprising:
a connection to a network;
a security collector adapted to receive security component information from a security component, said security component information comprising:
a security component identifier;
a status for said security component;
a last update time for said security component; and
a source for said security component;
a policy collector adapted to receive a policy definition for said security component; and
a user interface adapted to display metadata about said security component, said metadata comprising security strength being determined from said best practice settings.

2. The security manager of claim 1 further comprising an adapter for said security component, said adapter being adapted to:
receive current settings from said security component;
receive said policy definition; and
determine said security strength from said current settings and said best practice settings.

3. The security manager of claim 1, said policy definition being obtained from a remote server connected to the Internet.

4. The security manager of claim 1 said user interface further adapted to display an aggregated security strength for plurality of security components.

5. The security manager of claim 1, said security component being operable on a separate device from said security manager.

6. The security manager of claim 1 further comprising:
a component updater adapted to receive an updated set of component settings, transfer said updated set of component settings to said security component.

7. The security manager of claim 6, said updated set of component settings being determined from a user input selecting a policy level and said policy definition.

8. The security manager of claim 1 further comprising a discoverer adapted to:
discover said security component;
obtain an adapter for said security component; and
add said security component to said user interface.

9. The security manager of claim 1, said policy definition comprising a plurality of classifications for said security strength.

10. The security manager of claim 1, said security component information further comprising a Uniform Resource Locator for a remote server having said best practice settings.

11. A method comprising:
receiving security component information from a security component, said security component information comprising:
a security component identifier;
a status for said security component;
a last update time for said security component; and
a source for said security component;
receiving a policy definition for said security component;
displaying metadata about said security component, said metadata comprising security strength being determined from said policy definition.

12. The method of claim 11 further comprising:
transferring said set of best practices to an adapter, said adapter being adapted to perform a method comprising:
receiving current settings from said security component;
receiving said policy definition; and
determining said security strength from said current settings and said best practice settings.

13. The method of claim 11 further comprising:
connecting to a remote server connected to the Internet; and
downloading said policy definition.

14. The method of claim 11 said policy definition comprising a plurality of classifications of a security strength.

15. The method of claim 111 further comprising:
displaying an aggregated security strength for plurality of security components.

16. The method of claim 11 further comprising:
receiving an updated set of component settings; and
transferring said updated set of component settings to said security component.

17. The method of claim 16 further comprising:
receiving a user input comprising a policy level setting; and
determining said updated set of component settings from said user input and said policy definition.

18. The method of claim 11 further comprising:
discovering said security component;
obtaining an adapter for said security component; and
adding said security component to said user interface.

19. A computer readable medium comprising computer executable instructions adapted to perform the method of claim 11.

20. A computer readable medium comprising a data structure comprising:
a first data field containing a security component identifier;
a second data field containing a status for said security component;
a third data field containing a last update time for said security component;
a fourth data field containing a source for said security component; and
a fifth data field containing a policy strength for said security component.
